(19) United States
(12) Patent Application Publication
(10) Pub. No.: US 2014/0067579 A1
(43) Pub. Date: Mar. 6, 2014

(54) LISTING A CANDIDATE SERVICE IN A SERVICE CATALOG

(71) Applicants: Lorraine M. Herger, Port Chester, NY (US); Neal M. Keller, Pleasantville, NY (US); Matthew A. McCarthy, Holly Springs, NC (US); Clifford A. Pickover, Yorktown Heights, NY (US)

(72) Inventors: Lorraine M. Herger, Port Chester, NY (US); Neal M. Keller, Pleasantville, NY (US); Matthew A. McCarthy, Holly Springs, NC (US); Clifford A. Pickover, Yorktown Heights, NY (US)

(73) Assignee: International Business Machines Corporation, Armonk, NY (US)

(21) Appl. No.: 13/621,131

(22) Filed: Sep. 15, 2012

Related U.S. Application Data
(63) Continuation of application No. 13/599,874, filed on Aug. 30, 2012.

(51) Int. Cl. G06Q 30/00

(52) U.S. Cl. 705/26.1

(57) ABSTRACT

A system and computer program product for listing a service in a service catalog. Feedback is received about a candidate service that is used to determine a score for the candidate service. It is determined whether the score for the candidate service exceeds a first threshold. If the score for the candidate service exceeds the first threshold, the candidate service is listed as a published service in the service catalog. Feedback is received about the published service that is used to determine a score for the published service. It is determined whether the score for the published service exceeds a second threshold. If the score for the published service exceeds the second threshold, a signal is sent to a service actualization unit to actualize the published service.

### CROSS-REFERENCE TO RELATED APPLICATIONS

This application is a continuation of and claims priority under 35 U.S.C. §120 to U.S. patent application Ser. No. 13/599,874 (“LISTING A CANDIDATE SERVICE IN A SERVICE CATALOG”) filed Aug. 30, 2012.

### BACKGROUND

This invention relates to service management, and more particularly, listing services in a service catalog.

Service catalogs are a listing of services available to users of a catalog. These catalogs have gained in popularity due to their increased usefulness. As software has become vitally important to virtually all industries, so has the availability of on demand software solutions.

This on demand software has been labeled “software as a service.” Accordingly, this type of software has found a niche in service catalogs. For example, a particular company may offer a service catalog that includes on demand software to its employees in order to meet the technology needs required by their employment. However, the complexity of software and the explosion of available services have created a need for an improved service catalog.

### BRIEF SUMMARY

Accordingly, one example of the present invention is a system for listing a service in a service catalog. The system includes a server that further includes a processor. The server is configured to receive first feedback about a service not published in the service catalog. The first feedback is used to determine a score for the service. The server is further configured to determine whether the first score for the service exceeds a first threshold. The server is also configured to list, if the first score for the service exceeds the first threshold, the service as a published service in the service catalog. The server is additionally configured to receive second feedback about the published service that is used to determine a second score for the service. The server is further configured to determine whether the second score for the service exceeds a second threshold. The server is also configured to send, if the second score for the service exceeds the second threshold, a signal to a service actualization unit to actualize the service.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a method for listing a service in a service catalog according to one embodiment of the present invention.

FIG. 2 shows a method for actualizing a published service in a service catalog according to one embodiment of the present invention.

FIG. 3 shows a server for listing a service in a service catalog according to one embodiment of the present invention.

FIG. 4 shows data structures associated with a service catalog and service thresholds according to one embodiment of the present invention.

FIG. 5 shows data structures associated with a candidate service according to one embodiment of the present invention.

FIG. 6 shows data structures associated with a published service according to one embodiment of the present invention.

FIG. 7 shows a candidate service recommendation exemplary display according to one embodiment of the present invention.

FIG. 8 shows a catalog service exemplary display with published service and a widget according to one embodiment of the present invention.

FIG. 9 shows a catalog service exemplary display with a published service and an indicator according to one embodiment of the present invention.

FIG. 10 shows examples of methods used to identify candidate services for a service catalog according to one embodiment of the present invention.

### DETAILED DESCRIPTION

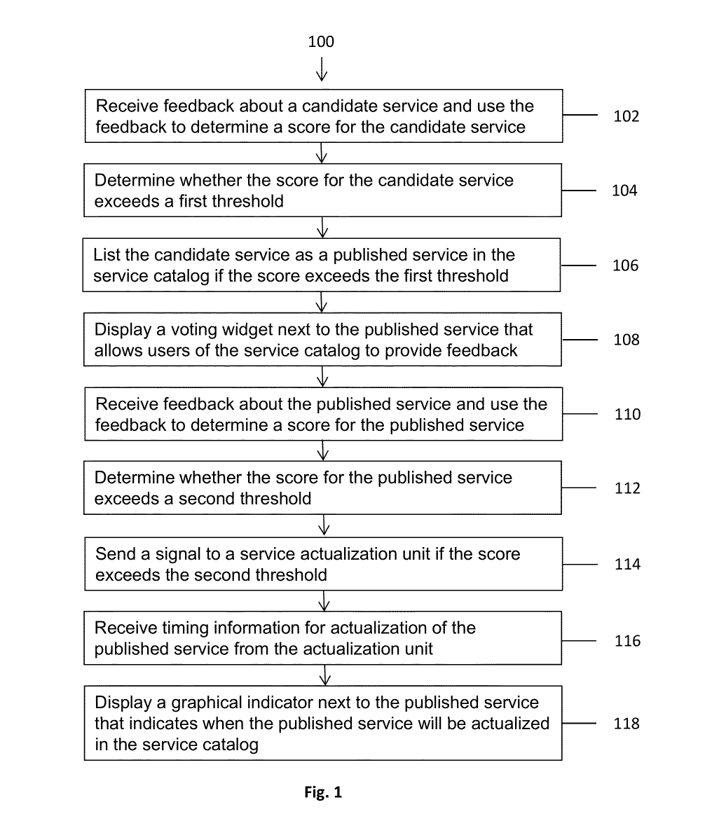

The present invention is described with reference to embodiments of the invention. Throughout the description of the invention reference is made to FIGS. 1-10. When referring to the figures, like structures and elements shown throughout are indicated with like reference numerals.

In an embodiment of the invention, the system creates a service catalog that includes entries for services that do not yet exist in the service catalog, but that are requested. For example, if the requests for a new service exceed a first threshold, the requested service may be displayed in the service catalog. By way of example, the requested service may be displayed with a graphical indication that indicates the service is not actualized or yet available. After the requested service is displayed in the service catalog, the requested service may be known as a published service. A published service may be created in the catalog by various means. For example, the published service may be revealed in the catalog based on a threshold number of user requests for the service.

In an embodiment of the invention, a published service is displayed based on an algorithm that determines that the published service is of interest to users of the service catalog. For example, an automated monitoring of news feeds, stock-market feeds, other catalogs, company reports, technical literature, broadcasts, periodicals, blogs, etc. may be used to determine that the service “employee rewards through non-financial means” is now of interest even if such a service does not already exist. Thus, a published service related to this need may be added to the service catalog. The other catalogs referred to above may include service catalogs of competitors, third-parties, other companies, other department in the same company, etc. In addition, certain sources, such as periodicals, may have metadata that is available for mining and that may augment the identification of candidate services. In an embodiment, the systems of particular service catalog users may be monitored for certain services to identify these services as candidate services.

In an embodiment of the invention, the system may employ one or more of service directory search results, latent semantic indexing results, or taxonomy based mining results in order to identify candidate services for publication in the service catalog. By way of example, service directory searching may include using structured dialogs and prompts in order to filter or search from lists of known services. This may include mining the Internet for services, filtering the services by domain and category, and naming and classifying the services. Subsequently the named and classified services may be explored to discover candidate services for the service catalog.

By way of example, latent semantic indexing may include using semantic analysis of descriptive text to identify and group same service requests. This may include performing natural language processing in order to determine which services possess similar enough descriptive text to conclude that they are the same service. By way of example, taxonomy based mining may include mining taxonomies for key words and metadata associated with candidate services. Additionally, the candidate services may be sorted and prioritized using a value or demand matrix. In an embodiment, the taxonomy based mining may be linked to defined semantic indexes to further refine the results.

In an embodiment of the present invention, the published service may become actualized if a score for the published service exceeds a second threshold. For example, when the number of requests exceeds a second threshold, a signal may be sent to acquire or create an actual service. The signal sent to facilitate a published service to become actualized may operate in many fashions. For example, the signal may be sent to one or more companies who are likely to have similar services or who may bid to create such a service. In one embodiment, the catalog provider may be unaware of certain means for actualizing a published service while users of the catalog may be aware of these means, e.g., using certain software to actualize a published service. Similarly, users of the catalog may be aware that a published service could become actualized by using components already in the current catalog. Thus, by way of example, catalog users may contribute to actualizing a published service by notifying the catalog provider and/or catalog users, or by providing a signal that associates the published service with an actual service.

In this way, the service catalog is beneficial to users because the users play an active role in the catalog creation and increase the chances of getting a needed service. The catalog is also beneficial to the catalog provider since the catalog is more likely to be useful to companies and individuals. Additionally, the catalog is beneficial to service providers because the providers may be able to create, offer, and sell these needed services.

In an embodiment of the invention, users may request a service that is already in the service catalog but was not found by the users, for example, due to a poorly worded service title or description. In such cases, a published service may be actualized simply by providing a pointer to the actual service. An additional use for this process is that it may lead to a better description for a service if a published service is discovered to already exist in the catalog, for example, under a different title.

In an embodiment of the invention, more than one service catalog can be presented to the user upon the user's request. For example, some users may desire to see only those catalogs with actualized services. Other users may want to see service catalogs with published services that are about to be actualized within a threshold wait time. By way of example, this may be presented to a user as a single catalog with a GUI that allows the user to control the nature of views and information in the catalog. The most useful catalog views, such as those catalog views preferred by users, can be discovered by known methods of monitoring. This embodiment may provide catalog users with a boost in productivity and efficiency since users could view actualized services along with published services that the users would have a direct influence over by providing feedback.

FIG. 1 shows a method for listing a service in a service catalog according to one embodiment of the present invention. The method includes a receiving step 102. During the receiving step 102, feedback is received about a candidate service and the feedback is used to determine a score for the candidate service. By way of example, the score may comprise a confidence level about whether the candidate service should be listed in the service catalog. In an embodiment of the invention, the received feedback about the candidate service may include implicit feedback or explicit feedback.

Examples of implicit feedback about the candidate service include a service directory searching result, a latent semantic indexing result, or a taxonomy based mining result. Examples of explicit feedback about the candidate service include a selection from a predetermined list or an input from a free-form text field. In an embodiment of the invention, the predetermined list may be generated using implicit feedback received about a plurality of candidate services. In an embodiment, implicit feedback may trigger a poll that seeks explicit feedback about one or more candidate services. For example, implicit feedback may be received about a plurality of candidate services, and a poll may be sent out to users of the service catalog to gather explicit feedback about the plurality of candidate services.

Received explicit feedback about the candidate service may additionally comprise different words that are meant to express similar concepts. For example, a first user may decide to use a first set of words to express positive feedback about the candidate service and a second user may decide to use a second set of words to express similar positive feedback about the candidate service. Thus, in an embodiment of the invention, a semantic analysis module, natural language processing, or topic-extraction module may be employed on the received feedback to help find and express composite user needs, i.e., determine that a number of users want the same candidate service. By way of example, these methods, along with latent semantic indexing, are commonly known to those skilled in the art. In an embodiment of the invention, users may enter feedback about a candidate service using a set of dialogue boxes and prompts to aid in standardizing the format and semantics of feedback. In another embodiment, human users may monitor the received feedback to aid in standardizing the language of the received feedback. After the receiving step 102 is completed, the method continues to determining step 104.

At determining step 104, it is determined whether the score for the candidate service exceeds a first threshold. In an embodiment of the invention, implicit feedback about the candidate service may be used to adjust the first threshold. After the determining step 104 is completed, the method continues to listing step 106. At listing step 106, the candidate service is listed as a published service in the service catalog if the score for the candidate service exceeds the first threshold. In an embodiment, users that provided feedback about the candidate service may be notified about the published service. After the listing step 106 is completed, the method continues to displaying step 108.

At displaying step 108, a voting widget is displayed next to the published service. By way of example, the voting widget allows users of the service catalog to provide feedback about the published service. If needed, the voting widget may restrict the number of times a user is permitted to vote or provide feedback about the published service. After the displaying step 108 is completed, the method continues to receiving step 110.

At receiving step 110, feedback is received about the published service and the feedback is used to determine a score for the published service. By way of example, the score may comprise a confidence level about whether the published service should be listed in the service catalog. In an embodiment of the invention, the received feedback about the published service may include implicit feedback or explicit feedback.

Examples of implicit feedback about the published service include a service directory searching result, a latent semantic indexing result, or a taxonomy based mining result. An example of explicit feedback about the published service includes votes from users of the service catalog. In an embodiment of the invention, a voting widget may be displayed next to the published service that allows users of the service catalog to provide explicit feedback about the published service. After the receiving step 110 is completed, the method continues to determining step 112.

At determining step 112, it is determined whether the score for the published service exceeds a second threshold. In an embodiment of the invention, implicit feedback about the published service may be used to adjust the second threshold. After the determining step 112 is completed, the method continues to sending step 114. At sending step 114, a signal is sent to a service actualization unit if the score for the published service exceeds the second threshold. After the sending step 114 is completed, the method continues to receiving step 116.

At receiving step 116, timing information for actualization of the published service is received from the actualization unit. After the receiving step 116 is completed, the method continues to displaying step 118. At displaying step 118, a graphical indicator that indicates when the published service will be actualized in the service catalog is displayed next to the published service in the service catalog.

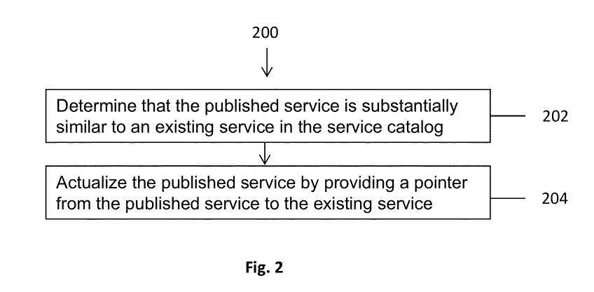

FIG. 2 shows a method for actualizing a published service in the service catalog in accordance with an embodiment of the invention.

The method of FIG. 2 includes a determining step 202. At determining step 202, it is determined that the published service is substantially similar to an existing service in the service catalog. After the determining step 202 is completed, the method continues to actualizing step 204. At actualizing step 204, the published service is actualized by providing a pointer from the published service to the existing service.

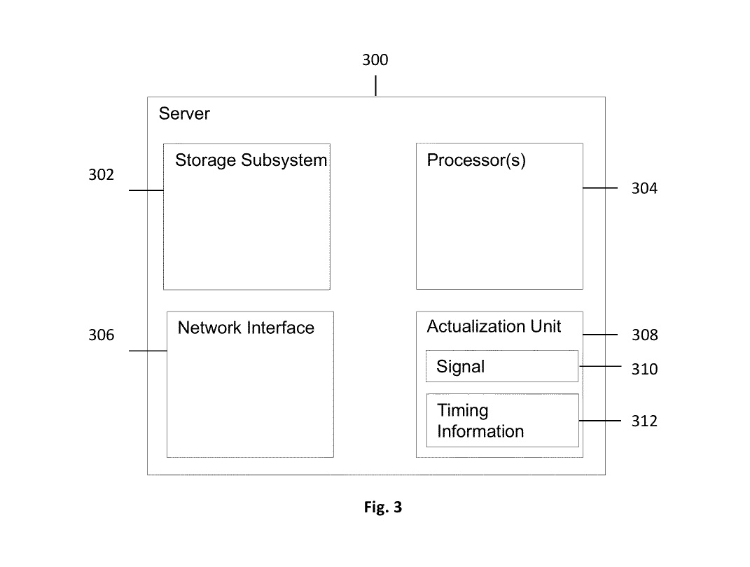

FIG. 3 shows a server 300 for listing a service in a service catalog according to one embodiment of the present invention. For example, server 300 of FIG. 3 may be used to implement the method steps of FIGS. 1-2. Server 300 includes storage subsystem 302, Processor(s) 304, network interface 306, actualization unit 308, signal 310, and timing information 312.

Storage subsystem 302 included in server 300 may comprise of a hard disk, a random access memory (RAM), a read-only memory (ROM), an erasable programmable read-only memory (EPROM or Flash memory), or any other suitable storage device or combinations thereof. Processor(s) 304 included in server 300 may comprise of one or more computer processors.

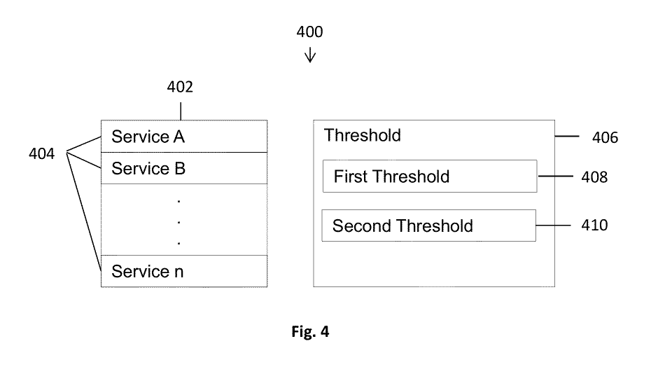

FIGS. 4-6 show data structures that may be used in combination with server 300 of FIG. 3 to list a service in a service catalog according to one embodiment of the present invention. For example, storage subsystem 302 of FIG. 3 may store the data structures of FIGS. 4-6.

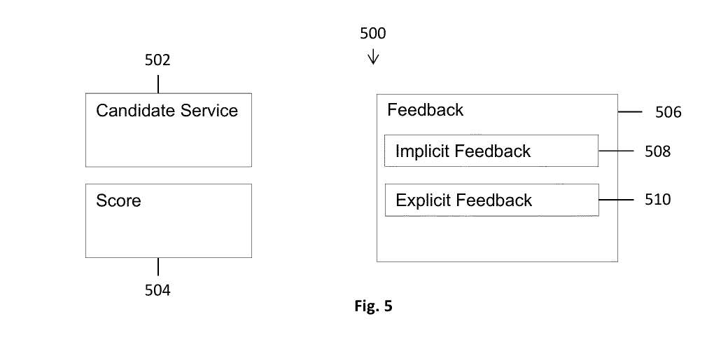

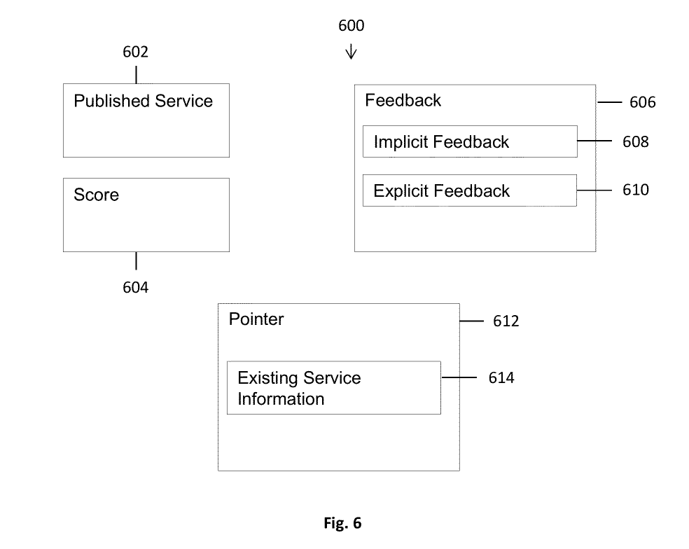

FIG. 4 shows data structures associated with the service catalog and thresholds. FIG. 4 includes service catalog 402, service(s) 404, and threshold 406, which includes a first threshold 408 and a second threshold 410. FIG. 5 shows data structures associated with a candidate service. FIG. 5 includes candidate service 502, score 504, and feedback 506, which includes implicit feedback 508 and explicit feedback 510. FIG. 6 shows data structures associated with a published service. FIG. 6 includes published service 602, score 604, feedback 606, which includes implicit feedback 608 and explicit feedback 610, and pointer 612, which includes existing service information 614.

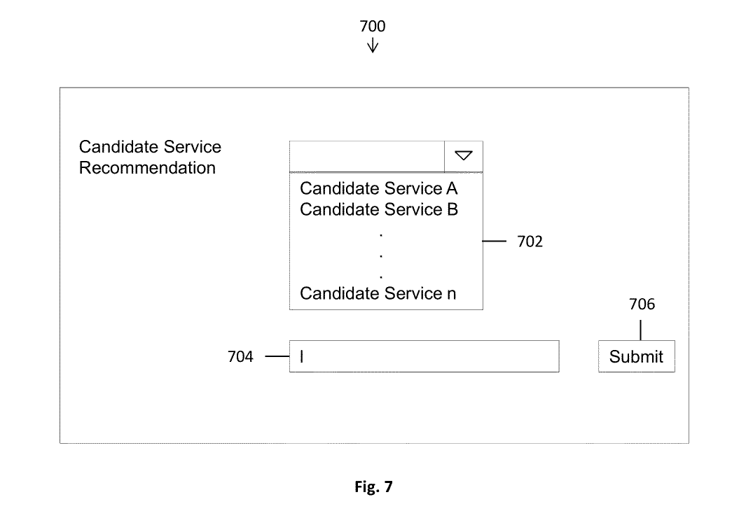

FIGS. 7-9 show exemplary displays that may be used in combination with server 300 of FIG. 3 to list a service in a service catalog according to one embodiment of the present invention. For example, server 300 of FIG. 3 may communicate with a client in order to display the exemplary displays of FIGS. 7-9. By way of example, the exemplary displays may comprise a portion of a web page that is displayed to a user of the service catalog. The exemplary displays may also comprise a portion of a native application that is displayed to a user of the service catalog. In addition, server 300 may utilize any commonly known method for displaying information to a user in order to display the exemplary displays of FIGS. 7-9.

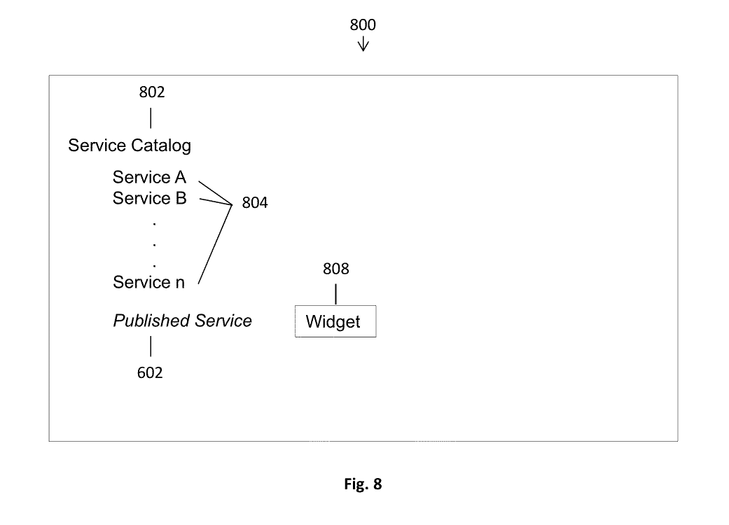

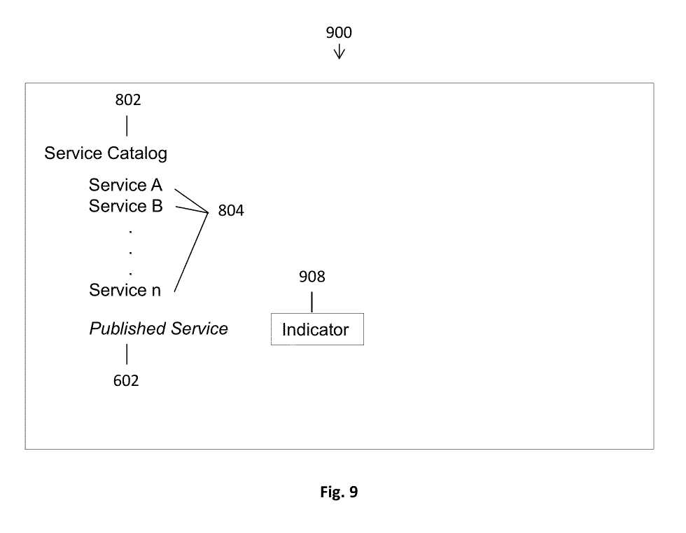

FIG. 7 shows a candidate service recommendation display 700. FIG. 7 includes a candidate service drop down menu 702, a free form text field 704, and a submit button 706. FIG. 8 shows a catalog service display 800 with a widget 808. FIG. 8 includes a service catalog 802, service(s) 804, a depiction of published service 602, and a widget 808. FIG. 9 shows a catalog service display 900 with an indicator 908. FIG. 9 includes service catalog 802, service(s) 804, a depiction of published service 602, and an indicator 908.

In an embodiment of the invention, server 300 receives feedback 506 about candidate service 502. The feedback 506 is used to determine a score 504 for candidate service 502. By way of example, score 504 comprises a confidence level about whether candidate service 502 should be listed in service catalog 402. In an embodiment of the invention, received feedback 506 about candidate service 502 includes one or more of implicit feedback 508 or explicit feedback 510.

Examples of implicit feedback 508 about candidate service 502 include a service directory searching result, a latent semantic indexing result, or a taxonomy based mining result. In an embodiment, implicit feedback 508 may identify candidate services offered in other service catalogs or services of interest to users that are not currently available in service catalog 402. By way of example, the system may rate candidate services based on popularity.

Examples of explicit feedback 510 about candidate service 502 include a selection from a predetermined list or an input from a free-form text field. In an embodiment, drop down menu 702 in display 700 includes a plurality of candidate services. Users of the service catalog may provide explicit feedback 510 about a candidate service listed in drop down menu 702 by selecting the candidate service. In an embodiment of the invention, a predetermined list of candidate services, such as the plurality of services in drop down menu 702, is generated using implicit feedback received about a plurality of candidate services. In another example, a user of the service catalog may provide explicit feedback 510 about candidate service 502 by typing input into free-form text field 704 and then pressing submit button 706.

In an embodiment, implicit feedback about one or more candidate services may trigger a poll that seeks explicit feedback about the one or more candidate services. For example, implicit feedback may be received about a plurality of candidate services, and a poll may be sent out to users of the service catalog to gather explicit feedback about the plurality of candidate services.

In an embodiment, explicit feedback 510 about candidate service 502 from free-form text field 704 may comprise different words that are meant to express similar concepts. For example, a first user may decide to use a first set of words to express positive feedback about candidate service 502 and a second user may decide to use a second set of words to express similar positive feedback about candidate service 502. Thus, in an embodiment of the invention, a semantic analysis module, natural language processing, or topic-extraction module may be employed on the received feedback to help find and express composite user feedback, i.e., determine that a number of users are expressing positive feedback about candidate service 502. By way of example, these methods, along with latent semantic indexing, are commonly known to those skilled in the art. By way of example, a service description module may prepare a standard description for candidate service 502. Additionally, if candidate service 502 is determined to be listed as a published service, this standard description may be displayed with the published service.

In an embodiment of the invention, server 300 determines whether score 504 exceeds a first threshold 408. By way of example, implicit feedback 508 about candidate service 502 may be used to adjust first threshold 408.

In an embodiment of the invention, candidate service 502 is listed as published service 602 in service catalog 802 if score 504 for candidate service 502 exceeds first threshold 408. For example, service catalog 802 may be displayed to users of the service catalog. Prior to score 504 exceeding threshold 408, service catalog 802 includes services 804. Thus, prior to listing published service 602, service catalog 802 may be the display of service catalog 402 and services 804 may be the display of services 404. After score 504 exceeds first threshold 408, published service 602 is listed in service catalog 802 along with services 804. By way of example, a service description module may prepare a standard description for published service 602 and the standard description may be displayed along with published service 602.

In an embodiment, published service 602 may be displayed in a manner slightly different from services 804 to differentiate a published service from a normal service. For instance, a published service may be displayed in italics, in bold, slightly grayed, in a different color, such as red, or in any other suitable means. In an embodiment, users that provided feedback 506 about candidate service 502 may be notified about published service 602.

In an embodiment of the invention, a voting widget 808 is displayed next to the published service 602. By way of example, voting widget 808 allows users of the service catalog to provide feedback about published service 602.

In an embodiment of the invention, server 300 receives feedback 606 about published service 602. The feedback 606 is used to determine a score 604 for published service 602. By way of example, score 604 comprises a confidence level about whether published service 602 should be listed in service catalog 402. In an embodiment of the invention, received feedback 606 about published service 602 includes implicit feedback 608 or explicit feedback 610.

Examples of implicit feedback 608 about published service 602 include a service directory searching result, a latent semantic indexing result, or a taxonomy based mining result. An example of explicit feedback 610 about published service 602 includes votes from users of the service catalog. In an embodiment of the invention, a voting widget 808 may be displayed next to published service 602. Voting widget 808 may allow users of the service catalog to provide explicit feedback about published service 602.

In an embodiment of the invention, server 300 determines whether score 604 exceeds a second threshold 410. By way of example, implicit feedback 608 about published service 602 may be used to adjust second threshold 410.

In an embodiment of the invention, server 300 sends signal 310 to actualization unit 308 if score 604 exceeds second threshold 410. By way of example, server 300 receives timing information 312 from actualization unit 308. Timing information 312 may comprise information about the timing for the actualization of published service 602.

In an embodiment of the invention, server 300 displays a graphical indicator 908 that indicates when published service 602 will be actualized in service catalog 402. By way of example, after timing information 312 is received from actualization unit 308, voting widget 808 is no longer displayed. Instead, graphical indictor 908 may be displayed next to published service 602. Graphical indicator 908 may indicate when published service 602 will be actualized in service catalog 402. Graphical indicator 908 may comprise a thermometer, a dial, a gauge, a bar, a digital countdown timer, an analog countdown timer, a pie chart, or any other suitable graphic that indicates a timing for actualization. In addition, by way of example, as published service 602 becomes closer to being actualized, a related visual representation may change. For example, the color of the text describing published service 602 may turn from red to amber when a promised date for the service is less than a predetermined period of time away, such as two weeks. Also, if it is discovered that published service 602 can be formed from existing components in service catalog 402 or in another service catalog, the actualization of published service 602 may not require a great amount of waiting time.

In an embodiment of the invention, server 300 determines that published service 602 is substantially similar to an existing service in service catalog 402. For example, server 300 may determine that published service 602 is substantially similar to one of the service(s) 404. In an embodiment of the invention, server 300 actualizes published service 602 by providing a pointer 612 from published service 602 to the existing service. By way of example, server 300 creates pointer 612 to actualize published service 602 and includes existing service information 614 in pointer 612.

An additional embodiment of the invention contemplates the merger of one business into another business. For example, a post-merger service catalog may be needed to accommodate the newly combined business which has the needs of both pre-merger businesses. This may be accomplished by using the service catalog of the first business and adding services that are needed by the second business. Therefore, the service catalog of the second business may be mined, and candidate services may be identified. From these candidate services, published services may further be identified and published within the new service catalog that is to service the newly merged company. Thus, employees from both newly merged businesses can provide feedback about which services will be useful. In an embodiment, employees may also provide explicit feedback about candidate services that they believe will be useful. Therefore, the employees may be able to augment the types of candidate services that are listed as published services in the service catalog by providing explicit feedback about candidate services.

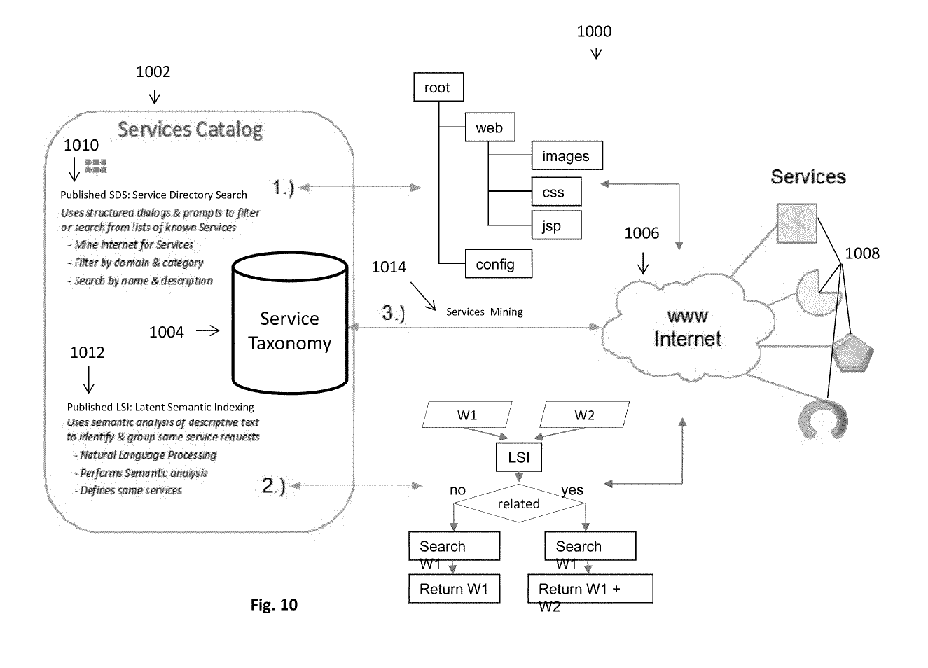

FIG. 10 shows examples of methods used to identify candidate services for a service catalog in accordance with an embodiment of the invention. FIG. 10 shows services catalog 1002, service taxonomy 1004, Internet 1006, services 1008, service directory search method 1010, latent semantic indexing method 1012, and services mining method 1014.

One sample method for identifying candidate services for services catalog 1002 is service directory searching method 1010. In an embodiment, service directory searching method 1010 includes mining Internet 1006 for services 1008 and classifying the mined services, for example by domain and category. These mined and classified services can then be searched to find candidate services.

A second sample method for identifying candidate services for services catalog 1002 is latent semantic indexing method 1012. In an embodiment, latent semantic indexing method 1012 takes requests for candidate services and analyzes them. The analysis includes querying semantic indexes to determine intelligent searches for services. By way of example, latent semantic indexing method 1012 can determine that two requests are similar enough that both intend to request the same service. A third sample method for identifying candidate services for services catalog 1002 is services mining method 1014. In an embodiment, service taxonomy 1004 provides keywords and metadata used to define searches across Internet content, for example across the blogosphere, for candidate services. The results of the searches may be analyzed, categorized, and weighted to determine potential implementation for the candidate services.

In an embodiment of the invention, service directory search method 1010, latent semantic indexing method 1012, and services mining method 1014 may be used in combination to identify candidate services. For example, service directory search method 1010 or service mining method 1014 may return a result set of possible candidate services, and latent semantic indexing method 1012 may be implemented on the possible candidate services to determine whether any of the possible candidate services request the same service. In an embodiment, these methods may be used to identify a candidate service, for example a service that enables paying bills by voice commands using a mobile device or smart phone.

As will be appreciated by one skilled in the art, aspects of the present invention may be embodied as a system, method or computer program product. Accordingly, aspects of the present invention may take the form of an entirely hardware embodiment of the invention, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for listing services in a service catalog, the system comprising: a server including a computer processor, the server configured to:
receive first feedback about a service not published in the service catalog and not created, the first feedback about the service being used to determine a first score for the service, the first feedback includes implicit feedback;
determine whether the first score for the service exceeds a first threshold;
if the first score for the service exceeds the first threshold, list the service as a published service in the service catalog;
receive second feedback about the published service, the second feedback about the published service being used to determine a second score for the service;
determine whether the second score for the service exceeds a second threshold; and
if the score for the service exceeds the second threshold, send a signal to a service actualization unit to create the service.

2. The system of claim 1, wherein at least one of the first feedback and the second feedback includes one or more of implicit feedback and explicit feedback.

3. The system of claim 2, wherein the implicit feedback comprises one or more of a service directory searching result, a latent semantic indexing result, and a taxonomy based mining result.

4. The system of claim 2, wherein the explicit feedback about the candidate service comprises one or more of a selection from a predetermined list and an input from a free-form text field.

5. The system of claim 4, wherein the predetermined list is generated from implicit feedback received for a plurality of services.

6. The system of claim 1, wherein implicit feedback is used to adjust one or more of the first threshold and the second threshold.

7. The system of claim 6, wherein the implicit feedback comprises one or more of a service directory searching result, a latent semantic indexing result, and a taxonomy based mining result.

8. The system of claim 1, wherein the server is further configured to list the service as the published service by displaying a voting widget next to the published service that allows users of the service catalog to provide explicit feedback about the published service.

9. (canceled)

10. The system of claim 1, wherein the server is further configured to:
receive timing information for actualization of the service from the actualization unit; and
based on the received timing information, display a graphical indicator next to the published service that indicates when the published service will be actualized in the service catalog.

11. A computer program product for listing services in a service catalog, the computer program product comprising:
a non-transitory computer readable storage medium having computer readable program code embodied therewith, the computer readable program code configured to:
receive first feedback about a service not published in the service catalog and not created, the first feedback about the service being used to determine a first score for the service, the first feedback includes implicit feedback;
determine whether the first score for the service not published in the service catalog exceeds a first threshold;
if the first score for the service exceeds the first threshold, list the service as a published service in the service catalog;
receive second feedback about the published service, the second feedback about the published service being used to determine a second score for the service;
determine whether the second score for the service exceeds a second threshold; and
if the second score for the service exceeds the second threshold, send a signal to a service actualization unit to create the service.

12. The computer program product of claim 11, wherein at least one of the first feedback and the second feedback includes one or more of implicit feedback and explicit feedback.

13. The computer program product of claim 12, wherein the implicit feedback comprises one or more of a service directory searching result, a latent semantic indexing result, and a taxonomy based mining result.

14. The computer program product of claim 12, wherein the explicit feedback comprises one or more of a selection from a predetermined list and an input from a free-form text field.

15. The computer program product of claim 14, wherein the predetermined list is generated from implicit feedback received for a plurality of services.

16. The computer program product of claim 11, wherein implicit feedback is used to adjust one or more of the first threshold and the second threshold.

17. The computer program product of claim 16, wherein the implicit feedback comprises one or more of a service directory searching result, a latent semantic indexing result, and a taxonomy based mining result.

18. The computer program product of claim 11, wherein the computer readable program code to list the service as the published service further comprises computer readable program code to display a voting widget next to the published service that allows users of the service catalog to provide explicit feedback about the published service.

19. (canceled)

20. The computer program product of claim 11, further comprising computer readable program code to:
receive timing information for actualization of the service from the actualization unit; and
based on the received timing information, display a graphical indicator next to the published service that indicates when the published service will be actualized in the service catalog.
